(19) United States
(12) Patent Application Publication
(10) Pub. No.: US 2025/0329706 A1
(43) Pub. Date: Oct. 23, 2025

(54) DRY POWDER OFFSET PRINTING

(71) Applicant: Sakuu Corporation, San Jose, CA (US)

(72) Inventor: Karl Littau, Los Altos Hills, CA (US)

(73) Assignee: Sakuu Corporation, San Jose, CA (US)

(21) Appl. No.: 19/254,927

(22) Filed: Jun. 30, 2025

Related U.S. Application Data
(60) Provisional application No. 63/820,906, filed on Jun. 10, 2025.

(51) Int. Cl. H01M 4/04

(52) U.S. Cl. CPC H01M 4/0414; H01M 4/0435; H01M 4/0471

(57) ABSTRACT

Systems, methods, and other embodiments associated with high speed, high precision direct deposition of patterned dry powder. In one embodiment, an example apparatus includes an intermediate substrate having an exterior surface configured to move patterned dry powder towards a target substrate, the exterior surface further configured to move and enclose a volume, a patterning device communicably coupled to the intermediate substrate and configured to form patterned dry powder on the exterior surface of the intermediate substrate, and a pressing mechanism configured to apply heat and pressure to the patterned dry powder positioned vertically above an upper surface of the target substrate to disrupt the adhesion of the patterned dry powder positioned vertically above the upper surface of the target substrate and transfer and adhere the patterned dry powder to the upper surface of the target substrate as a fused patterned layer.

### CROSS REFERENCE TO THE RELATED APPLICATIONS

This application is related to the pending U.S. patent application Ser. No. 18/391,024, filed on Dec. 20, 2023, and entitled “Electrode Fabrication Process”, the entire contents of which are incorporated herein by reference. This application is further related to the pending U.S. patent application Ser. No. 19/072,702, filed on Mar. 6, 2025, and entitled “Intermediate Surface to Substrate Powder Transfer System and Method”, the entire contents of which are incorporated herein by reference. This application is further related to the pending U.S. patent application Ser. No. 19/254,887, filed on Jun. 30, 2025, and entitled “Dry Powder Screen Printing”, the entire contents of which are incorporated herein by reference.

### TECHNICAL FIELD

The embodiments generally relate to material deposition systems and material patterning systems that can include powder printing systems, powder deposition systems, 3D printing systems, and additive manufacturing machines and systems. In particular, the embodiments generally relate to apparatus, methods, and systems for processing patterned dry material such as powder and transferring the patterned dry powder directly onto a target substrate (e.g., a conveyed substrate) as a fused patterned layer using dry powder offset printing.

### BACKGROUND

In present powder deposition systems, powder is deposited from a hopper onto a substrate. The deposited powder is non-uniform and can require several iterative smoothing or conditioning processes which in turn requires adjustment and control of powder deposition from the hopper to minimize powder non-uniformities. The direct deposition of a uniform dry patterned powder onto a substrate can reduce the need for additional powder processing for manufacturing a product. Generally, precise control and high-speed deposition of dry powder, particularly patterned powder, can be challenging using current material dispensers found in powder printing systems, 3D Printing systems, and additive manufacturing machines and systems. One problem with current material dispensers, as implemented with conveyed substrates, involves the use of a hopper or a feeder which dispenses material such as dry powder as a nonuniform powder pile. The powder pile dispensed onto the substrate by the hopper may require further smoothing and conditioning to obtain a uniform and smooth surface. Once the powder surface is smoothed out and uniform on the substrate, it may then be patterned. In order to improve deposition speed and powder surface uniformity, the hopper/feeder surface geometries, surface coating, agitation, and dispensing mechanism may be adjusted to obtain a consistent powder mass flow rate for the powder pile. However, the powder can often still require further smoothing and conditioning to obtain a uniform powder layer for patterning and compaction at a calender stage. Another problem with the above material dispenser includes the lack of precise control of powder deposited at high speeds as it is mechanically agitated/actuated to be transferred onto the substrate which tends to result in non-uniform powder deposition. Further, while consistent powder mass flow rate is desirable and can aide in downstream powder processing such as smoothing and compaction of the dry powder, the lack of depositing patternable powder can limit the shape, features, feature sizes, and other qualities of the deposited powder. A problem with material dispensers, as implemented with build platforms (e.g., powder bed systems or binder jetting 3D printing system), involves the use of a recoater, a roller, a blade or a horizontal bar to deposit powder particles which tend to have larger particle sizes leading to thick layers and rough surfaces, which limits the feature sizes and printing resolution and may also create large voids which prevent full densification during sintering processes. Moreover, the process of depositing a layer, patterning the layer with binder, and curing the binder can be a slow and time-consuming process for manufacturing a product. Therefore, there is a need for a dry powder printing system and method that can provide precise control, uniformity, feature size, speed, shapes, and other qualities for depositing a patterned powder. Moreover, there is a need for a simpler design that can reduce or eliminate the need for multiple smoothing rollers, conditioning rollers, complicated hopper configurations, and various energy sources for facilitating controlled, precise, or high-speed powder deposition.

### SUMMARY

In an implementation, an apparatus including an intermediate substrate having an exterior surface configured to move patterned dry powder towards a target substrate, the exterior surface further configured to move and enclose a volume; a patterning device communicably coupled to the intermediate substrate and configured to form patterned dry powder on the exterior surface of the intermediate substrate; and a pressing mechanism configured to apply heat and pressure to the patterned dry powder positioned vertically above an upper surface of the target substrate; wherein the applied heat and pressure from the pressing mechanism disrupts the adhesion of the patterned dry powder positioned vertically above the upper surface of the target substrate; and wherein the heat and pressure applied to the patterned dry powder transfers and adheres the patterned dry powder to the upper surface of the target substrate as a fused patterned layer.

In another implementation, a method including moving patterned dry powder on an exterior surface of an intermediate substrate towards a target substrate, the exterior surface further configured to move and enclose a volume; forming patterned dry powder on the exterior surface of the intermediate substrate; positioning the patterned dry powder vertically above an upper surface of the target substrate; applying heat and pressure to the patterned dry powder positioned vertically above an upper surface of the target substrate to disrupt the adhesion of the patterned dry powder; and transferring and adhering the patterned dry powder to the upper surface of the target substrate as a fused patterned layer.

### BRIEF DESCRIPTION OF THE DRAWINGS

The accompanying drawings, which are incorporated in and constitute a part of the specification, illustrate various systems, apparatus, methods, and one or more implementations of the disclosure. It will be appreciated that the illustrated element boundaries (e.g., boxes, groups of boxes, or other shapes) in the figures represent one implementation of the boundaries. In some implementations one element may be implemented as multiple elements or that multiple elements may be implemented as one element. In some implementations, an element shown as an internal component of another element may be implemented as an external component and vice versa. Furthermore, elements may not be drawn to scale. The drawing figures depict one or more implementations in accord with the present teachings, by way of example only, not by way of limitation. It is to be understood that the drawings are designed for the purpose of illustration only and not as a definition of the limits of the present disclosure. In the figures, like reference numerals refer to the same or similar elements. Furthermore, it should be understood that the drawings are not necessarily to scale. A complete understanding of the present implementations and the advantages and features thereof will be more readily understood by reference to the following detailed description when considered in conjunction with the accompanying drawings wherein:

FIG. 1A illustrates one embodiment of an offset printing system for high speed, high precision deposition of fused patterned layer(s) directly onto a target substrate, in accordance with aspects of the present disclosure;

FIG. 1B illustrates one embodiment of an offset printing system for high speed, high precision deposition of fused patterned layer(s) directly onto a target substrate, in accordance with aspects of the present disclosure;

FIG. 1C illustrates one embodiment of an offset printing system for high speed, high precision deposition of fused patterned powder layer directly onto a target substrate, in accordance with aspects of the present disclosure;

FIGS. 2A-2D illustrates one embodiment of an offset printing system for high speed, high precision deposition of fused patterned layer(s) directly onto a target substrate as a structured electrode, in accordance with aspects of the present disclosure;

FIG. 3 illustrates one embodiment of a flowchart depicting a process for facilitating high speed, high precision deposition of fused patterned layer(s) directly onto a target substrate with precise control of powder size, shape, and uniformity, in accordance with aspects of the present disclosure.

### DETAILED DESCRIPTION

Systems and methods are described herein as associated with dry powder offset printing and fused patterned layer deposition for facilitating high speed, high precision deposition of a fused patterned layer directly onto a target substrate with precise control of powder feature size, shape, uniformity, improved powder deposition speed, and other qualities and features as described herein for depositing a patterned powder. Current powder deposition systems and methods for battery manufacturing include a powder bed system and a conveyor/roll system can often lead to nonuniform powder deposition and lack of precise control of powder feature sizes, shapes, uniformity, improved powder deposition speed, and other qualities. For example, in the powder bed system (i.e., binder jetting 3D printing system), powder is deposited using a build platform. The current process requires the powder to be extensively engineered to achieve free-flowing behavior for deposition, which significantly limits the range of materials that can be used for such applications. Moreover, the process of depositing a layer, patterning the layer with a binder, and curing the binder can be a slow and time-consuming process for manufacturing a product. As another example, the powder deposition in conveyor/roll systems typically involves the use of a hopper or a feeder which dispenses material such as dry powder as a nonuniform powder pile. In order to improve deposition speed and powder surface uniformity, the hopper/feeder surface geometries, surface coating, agitation, and dispensing mechanism may be adjusted to obtain a consistent powder mass flow rate for the powder pile. However, the powder can often still require further smoothing and conditioning to obtain a uniform powder layer for patterning and compaction at a calender stage. Further, the material dispenser can lack precise control of powder deposited at high speeds as powder is mechanically agitated/actuated to be transferred onto the substrate, which tends to result in non-uniform powder deposition.

The present disclosure solves these problems and others using dry powder offset printing system having an intermediate substrate to receive patterned dry powder and a target substrate that receives the fused patterned layer directly from the intermediate substrate. The offset printing system may be coupled to a patterning system. The patterning system may transfer and/or form patterned dry powder on the intermediate substrate. The offset printing system is configured to press and heat the patterned dry powder onto the target substrate to transfer a fused patterned layer to the target substrate. Thus, dry powder may be deposited as a fused patterned layer onto the target substrate. The fused patterned layer may be received onto a conveyed target substrate such as a current collector web on a roll-to-roll system. The offset printing system may include conditioning systems and a directed energy system to facilitate and/or perform flow of the powder and/or separation of powder from the intermediate substrate. The directed energy may be spatially and temporally modulated thereby separating a patterned dry powder from the exterior surface of the intermediate substrate to the target substrate. Further, the directed energy may be spatially and temporally modulated thereby removing residual powder from the exterior surface of the intermediate substrate. Moreover, the patterned dry powder may also be conditioned or treated on the intermediate substrate or the target substrate as needed. The exterior surface of the intermediate substrate may be cleaned and pre-/post-conditioned prior to receiving patterned dry powder for transfer to the target substrate. The exterior surface of the intermediate substrate may be coated or conditioned/treated to facilitate and/or perform adhesion of the patterned dry powder to the intermediate substrate and separation from the intermediate substrate (and adhesion) to a target substrate. The powder may be conditioned/treated on the target substrate to activate a binder, adhere the powder to the target substrate, and facilitate adhesion and/or cohesiveness of the dry powder. Other benefits and advantages of the offset printing system are described herein. Moreover, the speed or rate of offset printing may be adjusted as desired.

### Patterning Devices and Methods

In many embodiments, the offset printing and patterning system may receive a patterned powder from a patterning system that includes screen printing, screen and stencil printing, and rotary screen/stencil printing for battery electrode manufacturing. The selection of patterning devices and systems for patterning dry powder and/or holding a target substrate to an intermediate substrate (e.g., holding and pressing patterned dry powder on a rotating body to a target substrate to transfer a fused patterned layer) is not restricted by the present disclosure; various powder delivery systems, powder dispensing units, and powder deposition system may be implemented such as a vibratory trough conveyor, a fluidized powder pipe conveyor, or an auger to deliver the powder to a single, centralized location on the intermediate substrate or to use a distribution device to distribute the powder across a region of the screen interior surface. Further, the patterned powder may include various materials, binders, and additives selected depending on the desired chemistry, application, and method of production. The target substrate, powder materials (powder components), and compositions may be conditioned as part of the printing process. Some examples of screen printing, screen and stencil printing, and rotary screen/stencil printing that may be utilized by the apparatus and method of the present disclosure are described in a related application by the Applicant (U.S. application Ser. No. 19/254,887), entitled “Dry Powder Screen Printing,” filed on Jun. 30, 2025, and which is hereby incorporated by reference. The related application describes apparatus, methods, and systems for patterning dry powder using screen printing, screen and stencil printing, and rotary screen/stencil printing and printing the patterned dry powder onto a target substrate (e.g., a conveyed substrate). In various examples described in the related application, the dry powder is received by a patterning system that is brought into contact with an upper surface of a target substrate. The patterning system draws or scrapes dry powder across a screen/stencil configuration. The screen/stencil configuration confines the dry powder within the screen/stencil in contact with the target substrate, and then the patterning system is removed from the target substrate to transfer/print the patterned powder on an upper surface of the target substrate. The related application further discloses a direct energy source to agitate or disrupt an adhesion of the dry powder or dry powder composition from the screen/stencil, and so forth.

### Conditioning, Cleaning, and Directed Energy Devices and Methods

In many embodiments, the offset printing and patterning system may receive powder and powder components for battery electrode manufacturing. The selection of powder materials and compositions is not restricted by the present disclosure; various materials, binders, and additives may be selected depending on the desired chemistry, application, and method of production. The target substrate, powder materials (powder components), and compositions may be conditioned as part of the printing process. Some examples of pre-/post-conditioning that may be utilized by the apparatus and method of the present disclosure are described in a related application by the Applicant (U.S. application Ser. No. 19/072,702), entitled “Intermediate Surface to Substrate Powder Transfer System and Method,” filed on Mar. 6, 2025, and which is hereby incorporated by reference. The related application describes apparatus, methods, and systems for transferring material such as dry powder from one surface or substrate (e.g., a conveyed or rotating surface or body) to a target substrate (e.g., a conveyed substrate) using a directed energy source as well as powder cleaning, conditioning, and recycling. In various examples described in the related application, the dry powder and/or dry powder components (e.g., binder, additives, etc.) may be conditioned by a heating device to apply heat to the dry powder or dry powder composition, an air jetting device to transfer the dry powder or dry powder composition from one surface/substrate to another, a suction/vacuum device to create a pressure differential between the ambient environment and a surface/substrate, one or more spreading or smoothing rollers and/or calenders to smoothen, compact or condition dry powder, a liquid or vapor infusion device to increase cohesion of the dry powder or dry powder composition (on the intermediate substrate and/or target substrate), a direct energy source to agitate or disrupt an adhesion of the dry powder or dry powder composition, and so forth. In various implementations, one or more conditioning devices may be provided in the offset printing and patterning system or apparatus, to apply heat and/or pressure to transfer a fused patterned layer to a target substrate 140 and/or activate a binder material contained in the powder composition of the patterned dry powder 130 to form a cohesive fused patterned layer 135 on the target substrate 140 (e.g., a current collector web for a battery). Further, the related application describes configuring the intermediate substrate 120 to include one or more surface features, shapes, or stencils that can pattern dry powder deposited on the exterior surface of the intermediate substrate 120.

### Offset Printing Apparatus

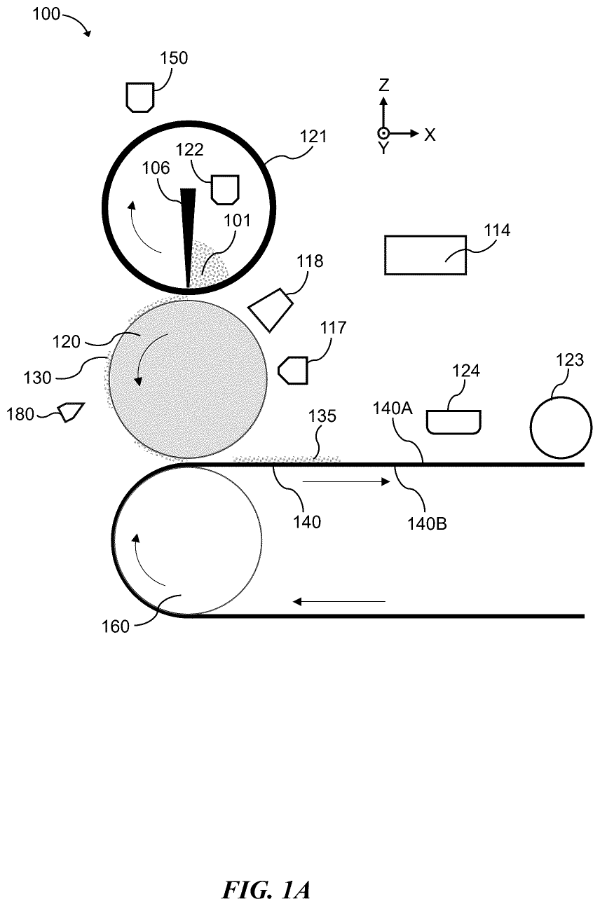

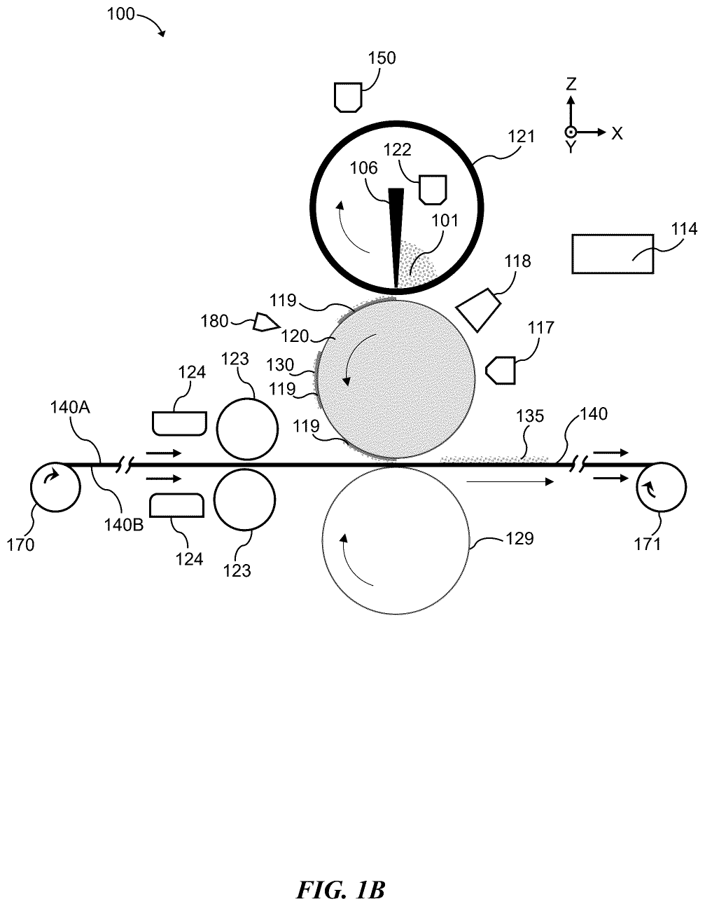

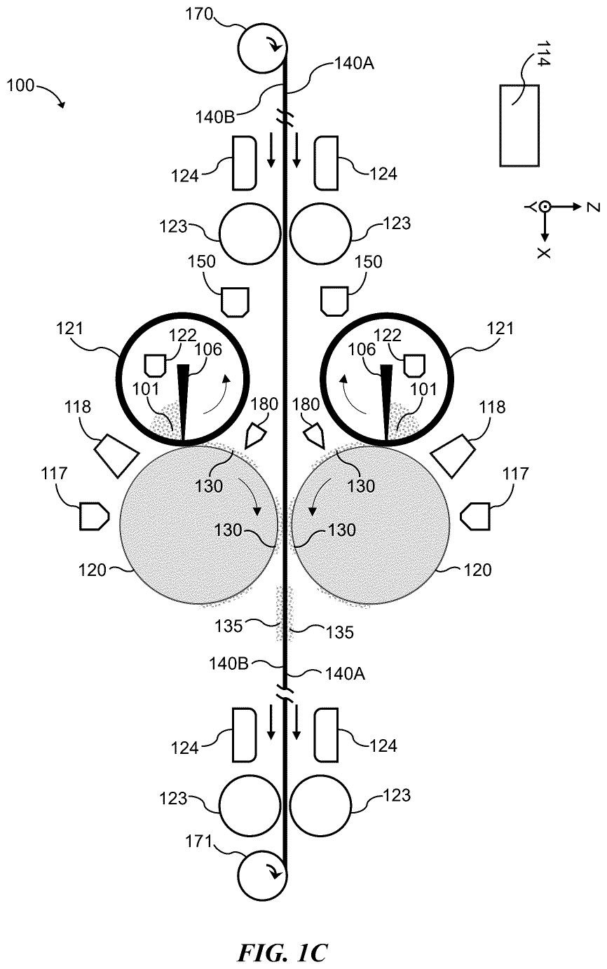

FIG. 1A-1C illustrate one embodiment of an offset printing system for high speed, high precision deposition of a fused patterned layer directly onto a target substrate, in accordance with aspects of the present disclosure. In some implementations, the offset printing system 100 may include an intermediate substrate 120, a patterning system 121, and a target substrate 140. The intermediate substrate 120 may receive patterned dry powder 130 from the patterning system 121. The intermediate substrate 120 may then transfer a fused patterned layer 135 to a target substrate 140. The intermediate substrate 120 may transfer the patterned dry powder 130 directly to the target substrate 140 using at least one of heat, radiation, and pressure thereby forming a fused patterned layer 135.

In some implementations, the patterning system 121 may be configured as a screen printing system or a screen and stencil printing system as described in the related application above. As an example, the patterning system 121 may be implemented using the above screen/stencil printing system (i.e., a screen/stencil printing configuration) whereby the interior volume of a patterning system 121 may receive dry powder 101 from a powder distribution system 122. The patterning system 121 then contacts the intermediate substrate 120 to begin transfer of dry powder 101 from an interior surface of the patterning system 121 through an exterior surface of the patterning system 121. In one embodiment, the patterning system 121 may include a squeegee 106 (or blade) that is drawn or scraped across a screen/stencil configuration to force or push dry powder 101 through the screen/stencil opening. Further, when the dry powder 101 passes through the screen opening/stencil opening, the dry powder 101 may be confined and patterned on the intermediate substrate 120 and within the screen/stencil opening. The contact between the intermediate substrate 120 and the patterning system 121 may then be removed and the patterned dry powder 130 can adhere to and remain on the intermediate substrate 120. In this way, for example, the patterned dry powder 130 may be coated as a uniform powder layer onto the intermediate substrate 120. Moreover, in certain implementations, the patterning system 121 may be configured to include a scanning laser device 180 which can selectively remove powder from the surface of the intermediate substrate 120 by laser powder removal. The scanning laser device 180 may facilitate further formation or definition of the pattern of patterned dry powder 130 by removing dry powder from the edges or surfaces of the patterned dry powder 130 moving on the exterior surface of the intermediate substrate 120.

In certain implementations, the patterning system 121 may be configured as a pattern transfer system using a directed energy source to vertically transfer a patterned dry powder onto a target substrate as described in the related application above. The patterned dry powder may then be heated and pressed to form a fused patterned layer. As an example, the patterning system 121 may be implemented using the above pattern transfer system whereby the exterior surface of the patterning system 121 may receive dry powder 101 from a powder distribution system 122, the patterning system 121 may process the dry powder 101 (i.e., condition, apply directed energy, etc.) then move and position the dry powder 101 directly and vertically above the intermediate substrate 120. The patterning system 121 may then apply a directed energy source to the dry powder 101 to disrupt an adhesion of the dry powder 101 and transfer a patterned powder 130 to the intermediate substrate 120. In many implementations, the patterning system 121 may be configured to include a cavity and the directed energy source may be positioned within an interior volume of the patterning system 121. The interior surface of the patterning system 121 may be irradiated, or applied with a directed energy source, to disturb an adhesion of the dry powder 101 and transfer the dry powder 101 to the intermediate substrate 120. In various implementations, the exterior surface of the patterning system 121 may be coated/treated/conditioned to maintain cohesiveness of the dry powder 101 and adhesion of the dry powder 101 to the exterior surface of the patterning system 121. Moreover, in certain implementations, the exterior surface of the patterning system 121 may be configured to include surface features (e.g., one or more regions having a roughened surface, grooves, protrusions, channels, stencils, etc.) to pattern or define a shape of the patterned dry powder 130, maintain adhesion, or obtain a desired surface topography of a transferred patterned dry powder 130 onto the intermediate substrate 120. In one implementation, the patterning system 121 may include a scanning laser configured to selectively remove powder from the surface of the intermediate roller by laser powder removal. Moreover, in certain implementations, the patterning system 121 may be configured to include a scanning laser device 180 which can selectively remove powder from the surface of the intermediate substrate 120 by laser powder removal. The scanning laser device 180 may facilitate further formation or definition of the pattern of patterned dry powder 130 by removing dry powder from the edges or surfaces of the patterned dry powder 130 moving on the exterior surface of the intermediate substrate 120.

In one implementation, the patterning system 121 may be configured to include a directed energy source 150 (e.g., a photocuring device, for example, directed UV source), a photo patterning mask (not shown) having one or more features or shapes for defining the patterning of dry powder 101. The patterning system 121 may further include a rotating body to receive, on its exterior surface, dry powder 101 configured to include a photocurable binder composition (e.g., UV curable binder composition). The dry powder 101 may be deposited on the exterior surface of the patterning system 121, the directed energy source 150 and photo mask (not shown) may be positioned adjacent to the dry powder 101. The directed energy source 150 may apply, for example, UV to the dry powder 101 to selectively cure the pattern or features of the photo mask on the dry powder 101. In some implementations, the dry powder 101 may be coated with photocurable binder composition then applied with the directed energy source 150 to selectively cure the pattern or features of the photo mask on the dry powder 101. After curing the dry powder 101 one or more conditioning devices or cleaning devices (e.g., air jetting, scanning laser, etc.) may be applied to remove non-treated (i.e., non-patterned powder) and/or residual dry powder 101 on the exterior surface of the patterning system 121 thereby forming the patterned dry powder 130. Moreover, in certain implementations, the patterning system 121 may be configured to include a scanning laser device 180 which can selectively remove powder from the surface of the intermediate substrate 120 by laser powder removal. The scanning laser device 180 may facilitate further formation or definition of the pattern of patterned dry powder 130 by removing dry powder from the edges or surfaces of the patterned dry powder 130 moving on the exterior surface of the intermediate substrate 120.

### Intermediate Substrate

Referring again to FIGS. 1A-1C, in some embodiments, the patterning system 121 may be configured to include an image cylinder that forms a patterned dry powder 130 or provides a patterned dry powder 130. Further, the intermediate substrate 120 may be configured to include a blanket cylinder that secures and transfers the patterned dry powder 130 towards and above an upper surface 140A of a target substrate 140. Moreover, the target substrate 140 may be conveyed using a conveyor 160 (e.g., including one or more rods, rollers, or cylinders). In some implementations, the conveyor 160 may be configured to include a hot impression cylinder to heat and press (an impression of) the patterned dry powder 130 onto the target substrate 140 as a fused patterned layer 135. In some implementations, the intermediate substrate 120 (e.g., the blanket cylinder) may be configured to apply at least one of heat and pressure during transfer of the patterned dry powder 130 to the target substrate 140 to form the fused patterned layer 135.

In a further aspect of the disclosure, in some implementations, the intermediate substrate 120 may transfer patterned dry powder 130 to a conveyed target substrate 140 by using at least one of heat, radiation, and pressure. The intermediate substrate 120 may be integrated with a heating device and configured to move vertically to press the patterned dry powder 130 onto the conveyed target substrate 140 as a fused patterned layer 135. Similarly, the conveyor 160 (roller or cylinder) may be integrated with a heating device and configured to move vertically to press the target substrate 140 onto the opposite surface of the patterned dry powder 130 to form the fused patterned layer 135 onto the target substrate 140.

In some embodiments, the patterned dry powder 130 may be temporarily adhered to the intermediate substrate 120 to facilitate, for example, further conditioning, processing, and/or formation of a patterned powder layer on the intermediate substrate 120. The processed patterned dry powder 130 may then be removed from the intermediate substrate 120 and transferred to the target substrate 140 prior to applying the heat and pressure to the patterned dry powder 130 to form a fused patterned layer 135 on the target substrate 140. With reference to FIG. 1B, in certain embodiments, the intermediate substrate 120 may include one or more pattern layers 119 (e.g., stencils) permanently formed on the exterior surface of the intermediate substrate 120 for the receiving and patterning a dry powder 101. The one or more pattern layers 119 (e.g., stencils) may be a movable or a compliant (compressible) fixture or layer. This allows the pattern layer 119 to move during application of heat and pressure ensuring sufficient pressure is applied to the patterned dry powder 130 without being obstructed by the pattern layer 119. Further, when the patterned dry powder 130 on the intermediate substrate 120 is applied to the target substrate 140 by heat and/or pressure, the heat and/or pressure induce an increase in cohesion of the fused patterned layer 135 and an increase of adhesion of the fused patterned layer 135 to the target substrate 140. Moreover, in some implementations, the increase in cohesion may be, in part, or in whole, accomplished by adding binder to the patterned dry powder 130 (or dry powder 101) which can be activated by heat, radiation, and/or pressure. With reference to FIG. 1C, in certain implementations, one or more intermediate substrates 120 may be distributed on each side of the target substrate 140 to facilitate simultaneous transfer of fused patterned layer 135 to both the upper surface 140A and the lower surface 140B of the target substrate 140. Moreover, the configuration, movement, and operation of the patterning systems 121, intermediate substrates 120, target substrate 140, conveyor 160, first spool 170, second spool 171, cleaning devices 117, conditioning units 118, conditioning devices 123, 124, directed energy sources 150, and scanning laser devices 180 may be synchronized and matched to facilitate deposition of patterned layer 135 on both upper surface 140A and lower surface 140B of the target substrate 140.

In many implementations, the intermediate substrate 120 may be a drum, a heat drum, a belt, a heated belt, a roller, a heated roller, a heated backing substrate, a powder uniformization device, and so forth. In some implementations, the exterior surface of the intermediate substrate 120 may be configured to include one or more roughened surface regions to facilitate better adhesion of the patterned dry powder 130 deposited thereon. For example, one or more regions of the exterior surface of the intermediate substrate 120 may include a roughened surface to increase static friction and improve the adhesion of the patterned powder 130 to the intermediate substrate 120. A surface roughness of between 1 μm and 100 um peak to valley roughness may be used. The intermediate substrate 120 may be made of metal, stainless steel, metal alloy, polymers, rubber coated metal, or composites such as fiber composites.

In a further aspect of the disclosure, the intermediate substrate 120 may be configured to apply low, moderate, or high pressure to the target substrate 140. Similarly, the conveyor 160 (e.g., including one or more rods, rollers, or cylinders) or conditioning device 129 opposite an intermediate substrate 120 may be configured to apply low, moderate, or high pressure to the target substrate 140. Moreover, the intermediate substrate(s) 120 may apply a low, moderate, or high temperature heat to the target substrate 140. Further, the conveyor 160 (e.g., including one or more rods, rollers, or cylinders) or conditioning device 129 may apply a low, moderate, or high temperature heat to the target substrate 140.

In certain implementations, one or more conditioning devices 123, 124, for example, powder uniformization devices 129 may be distributed on one or more sides of the target substrate 140. In one embodiment, one or more powder uniformization devices may be distributed on each side of the target substrate 140. Further, one or more powder uniformization devices may be configured to apply low, moderate, or high pressure to either side of target substrate 140 or fused patterned layer 135. Moreover, the one or more powder uniformization devices may be placed throughout the offset printing system 100 (i.e., printing apparatus) to apply a low, moderate, or high temperature heating to the target substrate 140, the fuse patterned layer 135, and materials or powder components (e.g., binders, conductive additives, and the active materials) thereon, or any combinations thereof. In many implementations, a powder uniformization device may include a heating device to spread and/or apply pressure to the fused patterned layer 135 (or patterned powder 130), and apply low, moderate, or high temperature heating to either side of target substrate 140.

In various implementations, the application of low pressure may be defined in a range from close to zero MPa to 10 MPa (Mega Pascals), application of moderate pressure may be defined in a range from 10 MPa to 500 MPa, and application of high pressure may be defined as above 500 MPa, and preferably in a range from 500 MPa to 5,000 MPa and above (based on dry powder composition). In some embodiments, a heating device may be utilized and configured to apply low, moderate, or high temperature heating to either side of target substrate 140 or patterned dry powder 130 during, prior to, or after transfer of the fused patterned layer 135 to the target substrate 140. In various implementations, the application of low temperature heating may be defined in a range from 25° C. to 90° C., application of moderate temperature heating may be defined in a range from 90° C. to 150° C., and application of high temperature heating may be defined as above 150° C., and preferably in a range from 150° C. to 225° C. In one preferred embodiment, the patterned dry powder 130 may be pressed at 175° C. with medium pressure for 0.01-1 seconds to form the fused patterned layer 135.

In certain implementations, the offset printing system 100 may include one or more cleaning devices 117 configured to clean and remove residual dry powder or one or more surface coatings from the intermediate substrate after transferring the fused patterned layer 135 to the upper surface 140A of the target substrate 140. Some examples of cleaning devices include an oscillating brush, an air jet device, one or more electrostatic chucks configured to apply an electric charge of reverse polarity to the intermediate substrate 120 to repel residual dry powder from the exterior surface of the intermediate substrate 120 into a receptacle (not shown) or onto another the conveyed substrate for reuse or recycling, or a directed energy device.

In some implementations, the offset printing system 100 may include one or more conditioning units 118 for conditioning the exterior surface of the intermediate substrate 120 as described in the above related application. Some examples of conditioning units 118 may include applying a film coating unit, spray coating unit, electric generating unit, or heating unit positioned adjacent to the exterior surface of the intermediate substrate 120 to improve at least one of a cohesiveness of the patterned dry powder 130 and an adhesion of patterned dry powder 130 to the intermediate substrate 120. Further, as described in the above related application, the offset printing system 100 may include one or more directed energy devices 150 to transferring energy to the patterned powder 130 to disturb adhesion of the patterned dry powder 130 from the exterior surface of the intermediate substrate 120. Some examples of directed energy devices 150 may include a vibration energy device, an acoustic energy device, and an ultrasonic energy device positioned adjacent to the exterior surface of the intermediate substrate 120 to disturb adhesion of the patterned dry powder 130 and/or remove residual dry powder from the exterior surface of the intermediate substrate 120.

### Target Substrate

With reference to FIGS. 1A-1C, in many implementations, the target substrate 140 may be conveyed or transferred from station to station and processed prior to (and after) transfer of the patterned dry powder 130 and formation of the fused patterned layer 135. In certain implementations, the offset printing system 100 may include a first spool 170 configured to release the target substrate 140 for processing and a second spool 171 configured to roll in a processed target substrate 140. The offset printing system 100 may include one or more conditioning devices 123, 124 positioned upstream from the second spool 171 and one or more conditioning devices 123, 124 positioned downstream from the first spool 170. In certain implementations, a primer layer (not shown) may be deposited and conditioned on the target substrate 140 using the one or more conditioning devices 123, 124, for example, a heating device and a smoothing or conditioning roller to condition the primer layer. In one embodiment, the offset printing system 100 may include a conveyor 160 that may be a belt conveyor. The belt conveyor may be configured to move the target substrate 140 in a longitudinal direction, horizontal to the volume enclosed by the intermediate substrate 120 (or tangential to the direction of rotation of the intermediate substrate 120). The conveyor 160, that is, the belt conveyor may be made of metal, stainless steel, metal alloy, polymers, or composites such as fiber composites. In some implementations, the target substrate 140 may be a current collector. In certain implementations, the target substrate 140 may be a polymer layer, ceramic layer, a metallic layer or electrically conductive layer to facilitate formation of an electrical component.

In various implementations, the target substrate 140 may be precoated with an adhesive layer (e.g., primer layer) which may also be activated by heat, radiation, pressure, or any combination thereof. Moreover, in certain implementations, simultaneous transfer of patterned dry powder 130 to both the upper surface 140A and the lower surface 140B of the target substrate 140 to form fused patterned layer(s) 135 can be performed with two intermediate substrates 120, one on each side of the target substrate 140 using heat and pressure from both sides. Further, heat or radiation can be applied to the point of contact through a means such as an infrared (or other) laser and a transparent intermediate substrate.

### Controller and Movements

With reference to FIGS. 1A-1C, in a further aspect of the disclosure, in some implementations, the offset printing system 100 may include a controller 114 configured for controlling the movement and operation of each system component, for example, patterning system 121, intermediate substrate 120, target substrate 140, conveyor 160, first spool 170, second spool 171, cleaning devices 117, conditioning units 118, conditioning devices 123, 124, and 129, directed energy source 150, and scanning laser device 180. The controller 114 may be programmed to independently adjust and synchronize the XYZ movement and powder deposition rate of patterning system 121, the XYZ movement of the intermediate substrate 120, conveyor 160, first spool 170, second spool 171, the XYZ movement and the rate/power of operation (e.g., adjusting speed, power, or frequency) of cleaning devices 117, conditioning units 118, conditioning devices 123, 124, and 129, directed energy source 150, and scanning laser device 180. In certain embodiments, the rotational speed (RPM) of the rotating body (e.g., intermediate substrate) when the patterning system 121 is configured as a rotating body. These adjustments and synchronizations may include matching the rate of motion in some or all directions such as matching the X motion of the target substrate 140 to the tangential motion of the patterning system 121 and intermediate substrate 120, for example, when the patterning system 121 is a rotating body or belt. This matching of motion may be accomplished though programming of the controller 114 and/or by the use of physical contact of the patterning system 121 with the intermediate substrate 120 and/or the physical contact of the intermediate substrate 120 with the target substrate 140. The contact portions of the target substrate 140 and/or intermediate substrate 120 may be configured, for example, shaped, smoothed, or coated to facilitate transfer of patterned dry powder 130 to the target substrate 140 and formation of one or more fused pattern layers 135.

### Surface Features and Structured Electrodes, Electrical Components

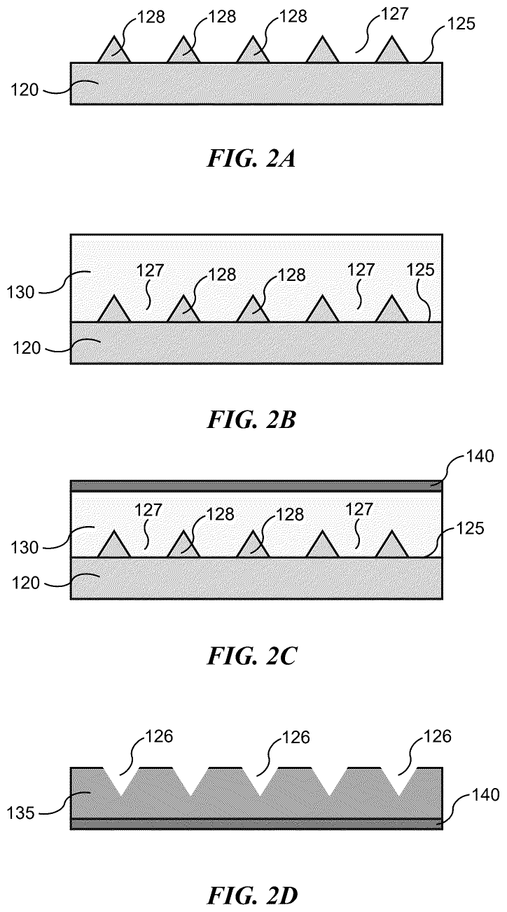

FIGS. 2A-2D illustrate one embodiment of an offset printing system for high speed, high precision deposition of fused patterned layer(s) directly onto a target substrate as a structured electrode, in accordance with aspects of the present disclosure. In some implementations, the offset printing system 100 may include one or more intermediate substrates 120 configured to include one or more surface features 128 positioned on an exterior surface 125 of the intermediate substrate 120, the dry powder composition, for example, binders, conductive additives, and the active materials may be selected and configured as needed to form a battery electrode. The applied heat and pressure to the patterned dry powder 130, for example, the intermediate substrate 120, the conveyor 160, the more conditioning devices 123, 124, or 129, or any combinations thereof, can transfer and fuse the patterned dry powder 130 into fused pattern layers 135 on the target substrate 140. In this way, the transferred patterned dry powder 130 can be formed as fused pattern layer 135 on the target substrate 140 for battery electrode manufacturing. Moreover, in certain embodiments, the one or more surface features 128 formed on the exterior surface 125 of the intermediate substrate 120 can be incorporated into the fused patterned layer 135 to form structured features such as channels/vias in the electrode. For example, periodic pillars and/or ridges may be formed on the exterior surface 125 of the intermediate substrate 120 which will create persistent depressions, holes, channels, and/or troughs in the fused patterned layer 135. In the case of battery electrodes, these features are intended to provide pathways for fast ion transport into and out of the electrode. The one or more surface features 128 may be formed (e.g., micro-molded) onto one or more regions of the intermediate substrate 120 as desired.

In a further aspect of the disclosure, in some implementations, the exterior surface 125 of the intermediate substrate 120 may include one or more surface features 128 to facilitate powder adhesion as well as being incorporated into the pattern of the fused patterned layer 135. In some implementations, one or more secondary surface features 127 (e.g., grooves, cavities, voids, spacings, etc.) may be formed between surface features 128. The one or more surface features may be configured to include any one of spikes, grooves, protrusions, pillars, guides, ridges, depressions, holes, channels, troughs, embossed patterns, engraved patterns, stencils, or any combinations thereof. Referring to FIG. 2A, in one implementation, the surface features 128 may include spikes formed on the exterior surface 125 of the intermediate substrate 120. Referring to FIG. 2B, the patterned dry powder 130 may be placed onto the surface features 128 by, for example, patterning system 121. Referring to FIG. 2C, the patterned dry powder 130 and the intermediate substrate 120 may be pressed and heated on a target substrate 140 (e.g., a current collector). Referring to FIG. 2D, the pressed and/or heated patterned dry powder 130 can form a fused patterned layer 135 on the target substrate 140 (i.e., current collector) having structured features 126 (e.g., inverted spikes) based on the surface features 128 (e.g., spikes) and/or secondary surface features 127.

As is readily contemplated, other large and small surface features may be embossed or engraved into the intermediate substrate 120 in order to provide patterns useful to the final compacted fused patterned layer 135. Moreover, surface features 128 may be configured to be one or more of a rough surface, saw-edge surface, or toothed surface of a predetermined periodicity to facilitate powder adhesion. The surface features 128 may be configured to include various surface patterns described that may be used individually or combined and spread across the exterior surface 125 of the intermediate substrate 120 to facilitate powder adhesion and form structure electrodes. In various implementations, the height of the surface features 128, from base/bottom to tip or edge of a surface feature, may be defined in a range from 10 μm to 500 um based on the properties and size of particles of the dry powder 101. Similarly, the spacing or pitch (or density of surface features) between each surface feature 128 may be defined in a range from 1 μm to 1000 um, based on the properties and size of particles of the dry powder 101. Further, as described herein, the intermediate substrate 120 may be made of stainless steel, for example, to facilitate formation of a fused patterned layer 135. The fused patterned layer 135 may be formed as structured electrodes, anodes, cathodes, or other electrical components having features defined by the intermediate substrate 120.

### Powder Mixing and Powder Considerations

In many embodiments, the offset printing and patterning system may receive powder and powder components for battery electrode manufacturing. The selection of powder materials and compositions is not restricted by the present disclosure; various materials, binders, and additives may be selected depending on the desired chemistry, application, and method of production. Some examples of powder compositions that may be utilized by the apparatus and method of the present disclosure are described in a related application by the Applicant (U.S. application Ser. No. 18/391,024), entitled “Electrode Fabrication Process,” filed on Dec. 20, 2023, and which is hereby incorporated by reference. The related application describes a method for manufacturing a battery electrode whereby dry particles are mixed with one or more electrode active materials, conductive additives, and one or more binder materials to form a binder-coated dry powder electrode material. The binder-coated dry powder electrode material can be used for a cathode or an anode. The dry powder electrode material is deposited onto an electrode current collector substrate using a dry powder dispensing device. In various examples described in the related application, the dry powder electrode material is a loose powder that can be poured at speed or mass rate from a dispensing device onto a moving current collector web in a roll-to-roll system. The dry powder electrode material may remain loose on the current collector web after deposition as it travels towards a compaction stage. After being poured onto the current collector, the loose dry powder electrode material is uniformly spread across the width of the moving current collector web by one or more spreading devices. The one or more spreading devices (e.g., conditioning devices) may include a doctor blade, one or more counter-rotating smoothing rollers, and one or more forward-rotating conditioning rollers.

Working with loose dry powders on a moving web prior to compaction is not trivial. Thus, in various examples, the constituent materials of the loose dry powder electrode material are chosen to achieve a balance between flowability and cohesion. The flowability of the loose dry powder electrode material is tuned to allow these materials to readily pour from the dispensing device, yet not too flowable that it scatters upon hitting the moving web or is easily disturbed by the movement and associated vibration of the web. Additionally, an electrode layer must be smooth and uniform in thickness after compaction, and a material that is too flowable does not compact well when calendered. Attempts to compact a highly flowable material with a calender often include streaks in the direction of the moving web as the flowable powder is pushed down the current collector web by the calender or the powder slips. Conversely, if the loose dry powder electrode material is too cohesive, it does not spread well and does not create a smooth and uniform layer when calendered or spread (e.g., there is often separation between individual clumps). Thus, the constituent materials of the loose dry powder electrode material are chosen to achieve a balance between flowability and cohesion. The powder layer, whether used for an electrode of an anode or cathode, must be smooth and uniform in thickness to improve a compaction rate at a calendering stage. In a further aspect of the disclosure, in various implementations, a morphology of a powder material can be tuned to improve adhesion, flowability and cohesion of the powder material on a substrate by improving powder mixing and powder mixture properties as can be achieved using an offset printing and patterning system as described herein.

In one implementation, the powder compositions may be used to form electrode layers using active material particles to form an anode or cathode, using one or more conductive additives, and one or more binder materials may be mixed to form a dry powder electrode material. In one embodiment, the one or more binder materials include 0.5-2 wt % PVDF which is mixed with active material particles and conductive additives. In other embodiments, 2-4 wt % PVDF is used. The active material particles and one or more binder materials, in one embodiment, are dry mixed to achieve a partial coating of PVDF over the active material particles that is between 50 and 85%. Additionally, the dry particles are mixed for a duration and at shear forces sufficient to attach 70-100% percentage of fine binder particles onto the surface of the active material particles to achieve a D50 of 7-12 um to achieve a Hausner ratio between 1.3-1.45.

In various implementations, the dry powder may be produced by dry mixing particles of one or more active electrode materials, conductive additives, and one or more binder materials, constituent materials of the loose dry powder electrode material are chosen to achieve a balance between flowability and cohesion. Examples of dry powder materials used to form a cathode or anode may include, for example and not limited to, carbon black, activated carbon, graphite, graphene, carbon fiber, and carbon nanotubes, copper, aluminum, nickel, silver, pearl graphite, carbon-polymer composite, metal-polymer composite, or combinations thereof. Examples of anode active material include lithium, lithium powder, molten lithium, semi-liquid lithium, lithium titanium oxide, silicon, silicon oxide, hard carbon, graphite, or any combinations thereof. Examples of cathode active material include lithium iron phosphate (LFP), lithium manganese iron phosphate (LMFP), lithium cobalt oxide (LCO), lithium manganese oxide (LMO), lithium nickel cobalt aluminum oxide (NCA), lithium nickel cobalt manganese aluminum oxide (NCMA), lithium nickel manganese cobalt oxide (NMC) and all its variants, lithium nickel manganese oxide (LMNO), lithium vanadium oxide (LVO), lithium iron disulfide, silver vanadium oxide, carbon monofluoride, copper oxide, sulfur, or combinations thereof. As an example, pearl graphite may be selected as a dry powder material for an anode formed by mixing an anode active material (e.g., graphite) with a conductive additive (e.g., conductive carbon) in a first mixing process. The pearl graphite may have sufficient flowability with a particle size of D50 in, for example, a range of 5-20 μm at ˜93 wt %. The conductive carbon, in this example, is 1.5 wt % with a particle size of D50 in the range of 1 nm to <1 μm.

Any suitable mixing process may be used, and multiple mixing processes may be implemented. As an example, a dry powder anode material may be formed by mixing an anode active material (e.g., graphite) with a conductive additive (e.g., conductive carbon) in a first mixing process. In some embodiments, a second mixing process may be performed to mix the graphite/conductive carbon mixture with a binder, for example but not limited to, Polyvinylidene Fluoride (PVDF). In one embodiment, 0.5-5 wt % binder may be used in the mixing process. Alternatively, higher concentrations of 12 wt % binder may also be used. The resulting composite powder has improved dry powder flowability compared with other pure powder, such as NMC by itself.

In one embodiment, a small amount of solvent can be added during the mixing process as a process aid. The solvent may be removed during later stages of the mixing process or immediately after. The result is increased binding efficiency as a result of modifying the shape and structure of the binder. The solvent can be removed through mild heating (80° C.-160° C.), thus “locking in” a modified structure of the binder to create a dry active material powder. This dry active material powder can then be deposited onto a current collector, as an example.

[Full binder coat] In a further aspect of the disclosure, various example implementations of binder material(s) may be utilized in powder engineering a powder material for a desired flowability, cohesion, handleability, and other benefits as described herein. In one implementation, the morphology of a powder material includes coating an active material particle with a binder layer to improve flowability of the material particles. In one embodiment, the dry powder electrode material particle may include an active material particle coated with a binder layer (e.g., Polyvinylidene Fluoride (PVDF)). The binder layer may be produced by dry mixing active material, 0.50-20 wt % binder, and conductive additives. The binder layer may be used to coat, in part or in whole, the surface of active material particles to promote flowability. For example, a relatively higher concentration of binder in loose dry powder electrode material has been shown to result in a balance of flowability and cohesion when mixed using relatively higher shear forces.

[Partial binder coat] In certain embodiments, an example morphology of a dry powder electrode material particle may include a spherical active material particle, such as cathode active material NMC, with partial binder coating. In one embodiment, the partial binder coating may be produced by dry mixing active material, 2 wt % PVDF, and conductive additives at relatively lower shear forces. As an example, a partial binder coating may cover 60-70% of the surface of an active material particle. In some embodiments, partial binder coating may limit the PVDF to being a surface adherent to the active material particles after compaction and binder activation resulting in sufficient space (e.g., voids, cavities, etc.) between active material particles in the electrode layer for electrolyte penetration whereby flowability is improved but electrochemical properties are limited. In some embodiments, an example morphology of a dry powder electrode material particle may include an amorphous active material particle, such as cathode active material LFP, with partial binder coating.

[Porous binder coat] In some embodiments, an example morphology of a dry powder electrode material particle may include spherical active material particle, such as cathode active material NMC, with porous binder coating. Additionally, the resulting morphology, its porous nature, and spread of the binder layer result, in one embodiment, in an increase in ionic conductivity due to capillary forces that encourage electrolyte penetration toward and access to active material particle. In one embodiment, the porous binder coating may be a matrix of nano PVDF particles (200-500 nm in diameter). The matrix, in one embodiment, may appear as a porous hard-spongelike layer composed of many nano PVDF particles attached to each other surrounding active material particle and can range from areas of no coverage on the surface of active material particle to areas of multiple nano PVDF particles thick. In one embodiment, a porous binder coating may be produced by dry mixing the active material, 2 wt % nano PVDF, and conductive additives at low shear forces. As an example, powder material particles may have a 70-90% binder surface coverage of active material particle. In certain embodiments, an example morphology of a dry powder electrode material particle may include amorphous active material particle, such as cathode active material LFP, with porous binder coating.

In some embodiments, higher shear forces exerted in the mixing of particles can cause the binder (e.g., full binder coating or partial binder coating of the active material particle) to at least partially deform and mold to the surface of the active material particles. Conversely, the relatively lower shear forces may be exerted when mixing dry powder electrode material particle cause the nano PVDF particles (e.g., porous binder coating) to adhere to the surface of active material particle and to each other (to form a three-dimensional matrix of particles) without complete deformation. Accordingly, porous binder coating causes increased friction having a Hausner ratio of roughly 1.38-1.45 and, thus, dry powder electrode material particle with porous binder coating of the active material particle does not flow as well as dry powder electrode material particles with full binder coating or partial binder coating of the active material particle yet can have superior electrochemical properties.

[Hybrid binder coat] In various implementations, any suitable thermoplastic binder compositions other than PVDF binder may be used to produce the dry powder material. In some embodiments, a hybrid binder composition may be used to obtain a desired balance between flowability and cohesion of the dry powder to produce a uniform powder layer. In various implementations, the hybrid binder composition may comprise a thermoplastic binder and a thermally curable binder, a UV curable binder, or two or more UV curable compositions where each binder is cured by UV radiation at a wavelength different from each other. When a hybrid binder comprising one or more of thermoplastic binder, thermally curable binder and UV curable binder is used, one or more of the components of the hybrid binder can be selectively cured or partially cured at a curing station to improve the cohesion and handleability of the dry powder material layer to prevent breaking down of the first layer during flipping through turn rollers.

In one embodiment, the hybrid binder composition may comprise one or more B-stage binder compositions which are partially cured, i.e., in the B-stage state. In various implementations, one or more of the components of the hybrid binder composition can be selectively cured or partially cured to tune the flowability and cohesion of the dry powder during the dry powder mixing process as described above or during a dry powder electrode manufacturing process. In various implementations, a dry powder material manufacturing process may include any suitable lubricating agents including organic materials (e.g., organic solvents) and other materials added to water that may be used to improve the cohesion and uniform compaction of the dry powder material. The amount of lubrication agent applied to the dry powder electrode material can be less than 10 wt %, preferably less than 5 wt %. In another example, the lubricating agent can serve as an activation agent to activate binder curing.

[Other binders] In some embodiments, the binder coated powder may comprise one or more of organic binders or inorganic binders or combinations thereof. The organic binder can comprise either a thermally curable composition, UV curable composition, or a photocurable composition or combinations thereof. In some implementations, the binder may comprise a ceramic precursor, such as polycarbosilane or polysiloxane which can thermally react and become part of the printed object during the post-printing process, e.g., sintering. In various embodiments, the binder coated powder can be made by any of the various particle coating techniques including but not limited to dry mixing, solvent evaporation, spray coating including spray drying and spray congealing, air suspension coating (also termed as fluidized bed coating), pan coating, centrifugal extrusion and multi-orifice centrifugal process, and the like. In various implementations, spray drying may be applied to the particles of the powder to impart fluidity on the powder in addition to, or in lieu of, other powder engineering processes described herein.

[Binder selection and limitations] In various aspects of the disclosure, powder engineering may include selection and configuration of one or more binder materials to hold the particles in place to make a cohesive layer. In many embodiments, application of binder material(s) and binder material amounts may be limited to the contact points between particles thereby limiting the binder contact points to promote sufficient electrolyte penetration into the resulting compacted powder layer (e.g., in a post-calendered electrode layer). There are multiple factors that may encourage the morphology of a dry powder electrode. One factor is the appropriate amount of binder, excessive use of binder would fill an unnecessary volume between particles, yet inadequate use of binder would not ensure sufficient particle to particle adhesion. Another factor is binder particle size; selection of small particles may not congeal as readily as larger agglomerates when melted, causing the binder to remain a surface adherent (i.e., keeping the binder from filling in the cavities between particles). Another factor is mixing intensity or shear force; the shear forces need to be strong enough to enable the binder particles to adhere to the active material particle surface, but not too strong that they deform and melt together and fully coat the particle surface limiting electrolyte penetration. Another factor is calendering pressure and heat; too much pressure and the structure collapses. Accordingly, the resulting morphology of dry powder electrode is a porous structure that, in one embodiment, increases ionic conductivity due to capillary forces that encourage electrolyte penetration toward and access to the active material particle.

### Method for Implementing Offset Printing

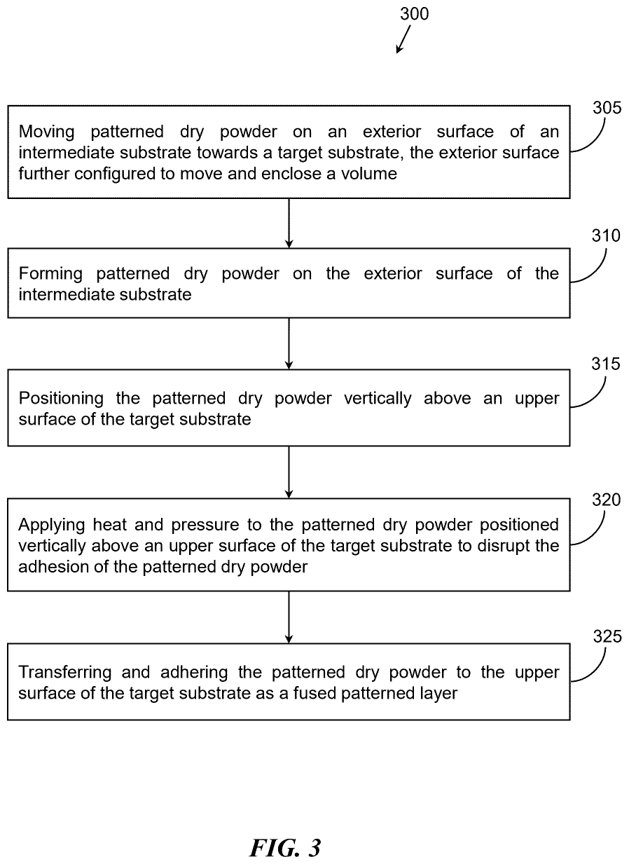

FIG. 3 illustrates an example flow chart showing a method for facilitating high speed, high precision powder deposition of fused patterned layer(s) onto a target substrate using dry powder offset printing with precise control of powder size, shape, and uniformity, in accordance with one or more embodiments of the present disclosure. These exemplary methods are provided by way of example, as there are a variety of ways to carry out these methods. Each block shown in FIG. 3 represents one or more processes, methods, or subroutines, carried out in the exemplary method. FIGS. 1A-1C and 2A-2D show example embodiments of carrying out the method of FIG. 3 for facilitating high speed, high precision powder deposition of fused patterned layer(s) directly onto a target substrate using dry powder offset printing with precise control of powder size, shape, and uniformity while minimizing additional processing and components that can reduce the flowability and cohesiveness of the dry powder during the process of patterned dry powder deposition onto a target substrate. Each block shown in FIG. 3 represents one or more processes, methods, or subroutines, carried out in the exemplary method. The exemplary method may begin at block 305. Method 300 may be used independently or in combination with other methods or process for facilitating high speed, high precision powder deposition of fused patterned layer(s) directly onto a target substrate using dry powder offset printing with precise control of powder size, shape, and uniformity while minimizing additional processing and components that can reduce the flowability and cohesiveness of the dry powder during the process of patterned dry powder deposition onto a target substrate. For explanatory purposes, the example process 300 is described herein with reference to the powder transfer system of FIGS. 1A-1C and 2A-2D. Further for explanatory purposes, the blocks of the example process 300 are described herein as occurring in serial, or linearly. However, multiple blocks of the example process 300 may occur in parallel. In addition, the blocks of the example process 300 may be performed in a different order than the order shown and/or one or more of the blocks of the example process 300 may not be performed. Further, any or all blocks of example process 300 may further be combined and done in parallel, in order, or out of order.

In FIG. 3, the exemplary method 300 of high speed, high precision powder deposition of fused patterned layers directly onto a target substrate using dry powder offset printing with precise control of powder size, shape, and uniformity while minimizing additional processing and components that can reduce the flowability and cohesiveness of the dry powder during the process of patterned dry powder deposition onto a target substrate, is shown. Method 300 begins at block 305. In block 305, the method includes moving patterned dry powder on an exterior surface of an intermediate substrate towards a target substrate, the exterior surface further configured to move and enclose a volume. In certain embodiments, the method may further include spray coating a rubbery layer on the exterior surface of the intermediate substrate to provide cushioning during application of heat and pressure to the patterned dry powder.

In block 310, the method includes forming patterned dry powder on the exterior surface of the intermediate substrate. In some implementations, the method may further include cleaning the exterior surface of the intermediate substrate to remove residual powder after transferring the patterned dry powder to the upper surface of the target substrate. Further, the method may include conditioning the exterior surface of the intermediate substrate using at least one of a film coating, spray coating, applying electric charge, or heating the exterior surface to improve at least one of a cohesiveness of the dry powder and an adhesion of the dry powder to the intermediate substrate. Moreover, in one implementation, the method may include transferring energy to the powder using an energetic means to remove residual powder or disturb adhesion of the patterned dry powder from the exterior surface of the intermediate substrate, the energetic means may be selected from the group consisting of vibration energy, acoustic energy, and ultrasonic energy, and wherein the energetic means is communicably coupled to the exterior surface of the intermediate substrate.

In block 315, the method includes positioning the patterned dry powder vertically above an upper surface of the target substrate. Further, in certain implementations, the method may further include forming one or more roughened surface regions on the intermediate substrate and forming patterned dry powder on the one or more roughened surface regions formed on the intermediate substrate. Further, in some embodiments, the exterior surface of the intermediate substrate may be configured to include one or more photo patterning masks, and the method of forming patterned dry powder on the exterior surface of the intermediate substrate may include selectively curing the dry powder on the exterior surface using the one or more photo patterning masks to form the patterned dry powder.

In block 320, the method includes applying heat and pressure to the patterned dry powder positioned vertically above an upper surface of the target substrate to disrupt the adhesion of the patterned dry powder. In some embodiments, the exterior surface of the intermediate substrate may be configured to include one or more surface features to facilitate powder adhesion, and the method of applying heat and pressure to the patterned dry powder further incorporates the one or more surface features into the pattern of the fused patterned layer, wherein the one or more surface features is selected from the group consisting of spikes, grooves, protrusions, pillars, guides, ridges, depressions, holes, channels, troughs, embossed patterns, engraved patterns, and stencils.

In block 325, the method includes transferring and adhering the patterned dry powder to the upper surface of the target substrate as a fused patterned layer. In some implementations, the method may further include moving the target substrate in a longitudinal direction, horizontal to the volume enclosed, and wherein the length of the fused patterned layer on the target substrate is equal to the length of the pressed and heated patterned dry powder.

It is noted that, although specific examples of processing steps for a printing operation have been illustrated and discussed, the order of the processing steps could be changed, if desired, and/or additional processing steps could be added.

In the following, further features, characteristics, and advantages of the instant application will be described by means of items:
Item 1. An apparatus, comprising: an intermediate substrate having an exterior surface configured to move patterned dry powder towards a target substrate, the exterior surface further configured to move and enclose a volume; a patterning device communicably coupled to the intermediate substrate and configured to form patterned dry powder on the exterior surface of the intermediate substrate; and a pressing mechanism configured to apply heat and pressure to the patterned dry powder positioned vertically above an upper surface of the target substrate; wherein the applied heat and pressure from the pressing mechanism disrupts the adhesion of the patterned dry powder positioned vertically above the upper surface of the target substrate; and wherein the heat and pressure applied to the patterned dry powder transfers and adheres the patterned dry powder to the upper surface of the target substrate as a fused patterned layer.
Item 2. The apparatus of claim 1, wherein the pressing mechanism is configured to apply heat and pressure to the patterned dry powder and transfer the patterned dry powder to the upper surface of the target substrate using at least one of: a powder uniformization device, the intermediate substrate, a heated roller, and a heated backing substrate.
Item 3. The apparatus of claim 1, wherein the target substrate comprises a current collector.
Item 4. The apparatus of claim 1, wherein the exterior surface of the intermediate substrate comprises one or more roughened surface regions, and wherein the patterned dry powder adheres to at least one of the one or more roughened surface regions.
Item 5. The apparatus of claim 1, further comprising a cleaning device for cleaning the exterior surface of the intermediate substrate to remove residual powder after transferring the patterned dry powder to the upper surface of the target substrate.
Item 6. The apparatus of claim 1, further comprising a conditioning unit for conditioning the exterior surface of the intermediate substrate, the conditioning unit comprising at least one of a film coating, spray coating, applying electric charge, or heating the exterior surface to improve at least one of a cohesiveness of the dry powder and an adhesion of the dry powder to the intermediate substrate.
Item 7. The apparatus of claim 1, further comprising an energetic means of transferring energy to the powder to remove residual powder or disturb adhesion of the patterned dry powder from the exterior surface of the intermediate substrate, wherein the energetic means is selected from the group consisting of a vibration energy device, an acoustic energy device, and an ultrasonic energy device, and wherein the energetic means is communicably coupled to the exterior surface of the intermediate substrate.
Item 8. The apparatus of claim 1, wherein the exterior surface of the intermediate substrate further comprises one or more surface features to facilitate powder adhesion, wherein the one or more surface features are incorporated into the pattern of the fused patterned layer during application of the pressing mechanism, and wherein the one or more surface features is selected from the group consisting of spikes, grooves, protrusions, pillars, guides, ridges, depressions, holes, channels, troughs, embossed patterns, engraved patterns, and stencils.
Item 9. The apparatus of claim 1, further comprising a belt conveyor, the belt conveyor configured to move the target substrate in a longitudinal direction, horizontal to the volume enclosed, wherein at least one of the intermediate substrate and the belt conveyor is made of metal, stainless steel, metal alloy, polymers, or composites such as fiber composites.
Item 10. The apparatus of claim 1, wherein the patterning device is a scanning laser which can selectively remove powder from the surface of the intermediate roller by laser powder removal.
Item 11. The apparatus of claim 1, wherein the intermediate substrate is a roller made of metal, stainless steel, metal alloy, polymers, rubber coated metal, or composites such as fiber composites.
Item 12. A method, comprising: moving patterned dry powder on an exterior surface of an intermediate substrate towards a target substrate, the exterior surface further configured to move and enclose a volume; forming patterned dry powder on the exterior surface of the intermediate substrate; positioning the patterned dry powder vertically above an upper surface of the target substrate; applying heat and pressure to the patterned dry powder positioned vertically above an upper surface of the target substrate to disrupt the adhesion of the patterned dry powder; and transferring and adhering the patterned dry powder to the upper surface of the target substrate as a fused patterned layer.
Item 13. The method of claim 12, further comprising moving the target substrate in a longitudinal direction, horizontal to the volume enclosed, and wherein the length of the fused patterned layer on the target substrate is equal to the length of the pressed and heated patterned dry powder.
Item 14. The method of claim 12, wherein the exterior surface of the intermediate substrate comprises one or more roughened surface regions, and wherein forming patterned dry powder on the exterior surface of the intermediate substrate further comprises forming patterned dry powder on the one or more roughened surface regions.
Item 15. The method of claim 12, further comprising cleaning the exterior surface of the intermediate substrate to remove residual powder after transferring the patterned dry powder to the upper surface of the target substrate.
Item 16. The method of claim 12, further comprising conditioning the exterior surface of the intermediate substrate using at least one of a film coating, spray coating, applying electric charge, or heating the exterior surface to improve at least one of a cohesiveness of the dry powder and an adhesion of the dry powder to the intermediate substrate.
Item 17. The method of claim 12, further comprising transferring energy to the powder using an energetic means to remove residual powder or disturb adhesion of the patterned dry powder from the exterior surface of the intermediate substrate, the energetic means is selected from the group consisting of vibration energy, acoustic energy, and ultrasonic energy, and wherein the energetic means is communicably coupled to the exterior surface of the intermediate substrate.
Item 18. The method of claim 12, wherein the exterior surface of the intermediate substrate further comprises one or more surface features to facilitate powder adhesion, wherein applying heat and pressure to the patterned dry powder further comprises incorporating the one or more surface features into the pattern of the fused patterned layer, and wherein the one or more surface features is selected from the group consisting of spikes, grooves, protrusions, pillars, guides, ridges, depressions, holes, channels, troughs, embossed patterns, engraved patterns, and stencils.
Item 19. The method of claim 12, wherein the intermediate substrate is a roller made of metal, stainless steel, metal alloy, polymers, rubber coated metal, or composites such as fiber composites.

### Definitions

A “powder”, “material deposited,” dry powder”, “dry powder material”, “dry powder electrode”, “dry powder anode”, “dry powder cathode”, “loose powder”, “loose dry powder”, “particle”, “particulate”, “powder material”, or “powder layer” as used herein includes, but is not limited to, any particle or particulate of a dry powder material, dry powder materials, or dry powder compositions that may be altered (e.g., mixed with one or more particles, binders, solvents, conductive additives, or active anode or cathode materials) and/or conditioned through one or more conditioning means to improve flowability, cohesion, and handleability, and are used herein interchangeably. The material deposited may include one or more layers or structures formed, and is not to be limited to electrodes, anodes, or cathodes, and can include any electrical component, surface, or component coating.

A “fused patterned layer”, “patterned layer”, or “fused layer”, as used herein includes, but is not limited to, any processing (e.g., adding heat, radiation, pressure) to transfer and fuse patterned powder or form cohesive patterned layers from an intermediate substrate to a target substrate. The target substrate, intermediate substrate(s), or any combinations thereof, may be configured to include rollers, calenders, backing substrates, or the like. Further, the target substrate or intermediate(s) may be configured to apply pressure, heat, compaction, radiation, or the like to fuse the patterned powder.

A “powder component” as used herein includes, but is not limited to, any of one or more particles, binders, polymers, solvents, conductive additives, or active anode or cathode materials that may be added to a powder. In some implementations, powder components may be selected and added as desired to improve electrical conductivity, flowability, cohesion, electrochemical properties, adhesion, handleability, and conditioning of the powder as well as other benefits as needed.

A “conditioning device,” “conditioning unit,” “processing,” “conditioning,” or “conditioning system,” as used herein, includes, but is not limited to, any apparatus, device, or method that can facilitate smoothing, pressing, heating, compaction, improving adhesion, cohesion, uniformity, compaction, electrochemical properties, or any other characteristic or property of the composite material, composite film, composite layer, substrate, and material deposited (e.g., dry powder and particles, additives, or components of the dry powder composition), and are used herein interchangeably.

A “agitation”, “actuation”, or “vibration” as used herein includes, but is not limited to, any application of mechanical energy to a surface that can emit longitudinal, radial, or transverse waves to disrupt or displace powder or material resting on the surface or impart energy to the powder or material to effectuate motion of the powder or material.

A “powder transfer system,” “powder transfer device,” “powder transfer apparatus,” “powder distribution device,” “powder distribution system,” or “powder distribution apparatus” as used herein, includes, but is not limited to, any system or apparatus that facilitates transfer of material from a moving intermediate surface/substrate onto a moving target surface/substrate including or excluding a container or structure having one or more openings for holding and dispensing material.

A “rotating body,” or “moving body,” as used herein, includes, but is not limited to, any device configured to facilitate movement of a substrate (or surface) to store, carry, and transport material deposited thereon onto a moving target substrate. As an example, a rotating body can include one or more rollers/rods coupled to one or more bendable or rotatable substrates. The substrate may be a belt, a roll, a flexible substrate, a continuous substrate, a segmented substrate, or a transparent substrate. The rotating body can have a plurality of distinct or segmented surfaces or substrates for receiving materials (e.g., a cog or a spline) whereby the substrate rotates about an axis to facilitate transport of material deposited thereon. The moving target substrate may be located at a distance away from a powder distribution or powder deposition system used to deposit the material onto the substrate.

A “stencil,” or “shape,” as used herein, includes, but is not limited to, patterned powder taking the shape of any letter/character shape (e.g., T, U, H, L, I, or other character shapes, etc.), any polygonal shape (e.g., a strip, a square, triangle, rectangle, etc.), or any curved or piece-wise rectilinear shape (e.g., a star shape, etc.). The powder may be patterned at any stage of processing using any one of a screen, stencil, plate, and wire mesh line, or any combinations thereof as described herein, including the initial stage of depositing a dry powder on a screen or interior surface of the patterning system. Moreover, patterning the powder may include the use of one or more conditioning devices, cleaning devices, and directed energy sources to pattern the powder, and transferring a patterned powder to the target substate.

### Definitions and Other Embodiments

In another embodiment, the described methods and/or their equivalents may be implemented with computer executable instructions. Thus, in one embodiment, a non-transitory computer readable/storage medium is configured with stored computer executable instructions of an algorithm/executable application that when executed by a machine(s) cause the machine(s) (and/or associated components) to perform the method. Example machines include but are not limited to a processor, a computer, a server operating in a cloud computing system, a server configured in a Software as a Service (SaaS) architecture, a smart phone, and so on. In one embodiment, a computing device is implemented with one or more executable algorithms that are configured to perform any of the disclosed methods.

In one or more embodiments, the disclosed methods or their equivalents are performed by either: computer hardware configured to perform the method; or computer instructions embodied in a module stored in a non-transitory computer-readable medium where the instructions are configured as an executable algorithm configured to perform the method when executed by at least a processor of a computing device.

While for purposes of simplicity of explanation, the illustrated methodologies in the figures are shown and described as a series of blocks of an algorithm, it is to be appreciated that the methodologies are not limited by the order of the blocks. Some blocks can occur in different orders and/or concurrently with other blocks from that shown and described. Moreover, less than all the illustrated blocks may be used to implement an example methodology. Blocks may be combined or separated into multiple actions/components. Furthermore, additional, and/or alternative methodologies can employ additional actions that are not illustrated in blocks. The methods described herein are limited to statutory subject matter under 35 U.S.C. § 101.

The following includes definitions of selected terms employed herein. The definitions include various examples and/or forms of components that fall within the scope of a term and that may be used for implementation. The examples are not intended to be limiting. Both singular and plural forms of terms may be within the definitions.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

The term “within a proximity”, “a vicinity”, “within a vicinity”, “within a predetermined distance”, “predetermined width”, “predetermined height”, “predetermined length” and the like may be defined between about 0.01 centimeter and about 0.5 meters. The term “coupled” is defined as connected, whether directly or indirectly through intervening components, and is not necessarily limited to physical connections. The connection may be such that the objects are permanently connected or releasably connected. The term “substantially” is defined to be essentially conforming to the particular dimension, shape, or other feature that the term modifies, such that the component need not be exact. For example, “substantially cylindrical” means that the object resembles a cylinder, but may have one or more deviations from a true cylinder. The term “comprising,” when utilized, means “including, but not necessarily limited to”; it specifically indicates open-ended inclusion or membership in the so-described combination, group, series, and the like.

The term “a predefined” or “a predetermined” when referring to length, width, height, or distances may be defined as between about 0.01 centimeter and about 0.5 meters.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the present disclosure, the disclosure, the present disclosure, other variations thereof and alike are for convenience and do not imply that a disclosure relating to such phrase(s) is essential to the present disclosure or that such disclosure applies to all configurations of the present disclosure. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

The word “exemplary” is used herein to mean “serving as an example, instance, or illustration.” Any embodiment described herein as “exemplary” or as an “example” is not necessarily to be construed as preferred or advantageous over other embodiments. Furthermore, to the extent that the term “include”, “have”, or the like is used in the description or the claims, such term is intended to be inclusive in a manner similar to the term “comprise” as “comprise” is interpreted when employed as a transitional word in a claim.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for.”

The previous description of the disclosed embodiments is provided to enable a person skilled in the art to make or use the disclosed embodiments. Various modifications to these embodiments will be readily apparent to those skilled in the art, and the principles defined herein may be applied to other embodiments without departing from the scope of the disclosure. Thus, the present disclosure is not intended to be limited to the embodiments shown herein but is to be accorded the widest scope possible consistent with the principles and novel features as defined by the following claims.

References to “one embodiment”, “an embodiment”, “one example”, “an example”, and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in one embodiment” does not necessarily refer to the same embodiment, though it may. The embodiments shown and described above are only examples. Many details are often found in the art such as the other features of an image device. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size, and arrangement of the parts within the principles of the present disclosure, up to and including the full extent established by the broad general meaning of the terms used in the claims. It will therefore be appreciated that the embodiments described above may be modified within the scope of the claims.

An “operable connection”, or a connection by which entities are “operably connected”, is one in which signals, physical communications, and/or logical communications may be sent and/or received. An operable connection may include a physical interface, an electrical interface, and/or a data interface. An operable connection may include differing combinations of interfaces and/or connections sufficient to allow operable control. For example, two entities can be operably connected to communicate signals to each other directly or through one or more intermediate entities (e.g., processor, operating system, logic, non-transitory computer-readable medium). Logical and/or physical communication channels can be used to create an operable connection.

“User”, as used herein, includes but is not limited to one or more persons, computers or other devices, or combinations of these.

While the disclosed embodiments have been illustrated and described in considerable detail, it is not the intention to restrict or in any way limit the scope of the appended claims to such detail. It is, of course, not possible to describe every conceivable combination of components or methodologies for purposes of describing the various aspects of the subject matter. Therefore, the disclosure is not limited to the specific details or the illustrative examples shown and described. Thus, this disclosure is intended to embrace alterations, modifications, and variations that fall within the scope of the appended claims, which satisfy the statutory subject matter requirements of 35 U.S.C. § 101.

To the extent that the term “includes” or “including” is employed in the detailed description or the claims, it is intended to be inclusive in a manner similar to the term “comprising” as that term is interpreted when employed as a transitional word in a claim.

To the extent that the term “or” is used in the detailed description or claims (e.g., A or B) it is intended to mean “A or B or both”. When the applicants intend to indicate “only A or B but not both” then the phrase “only A or B but not both” will be used. Thus, use of the term “or” herein is the inclusive, and not the exclusive use.

What is claimed is:

1. An apparatus, comprising:
an intermediate substrate having an exterior surface configured to move patterned dry powder towards a target substrate, the exterior surface further configured to move and enclose a volume;
a patterning device communicably coupled to the intermediate substrate and configured to form patterned dry powder on the exterior surface of the intermediate substrate; and
a pressing mechanism configured to apply at least one of heat and pressure to the patterned dry powder positioned vertically above an upper surface of the target substrate;
wherein the applied heat and pressure from the pressing mechanism disrupts the adhesion of the patterned dry powder positioned vertically above the upper surface of the target substrate; and
wherein the heat and pressure applied to the patterned dry powder transfers and adheres the patterned dry powder to the upper surface of the target substrate as a fused patterned layer.

2. The apparatus of claim 1, wherein the pressing mechanism is configured to apply heat and pressure to the patterned dry powder and transfer the patterned dry powder to the upper surface of the target substrate using at least one of: a powder uniformization device, the intermediate substrate, a heated roller, and a heated backing substrate.

3. The apparatus of claim 1, wherein the target substrate comprises a current collector.

4. The apparatus of claim 1, wherein the exterior surface of the intermediate substrate comprises one or more roughened surface regions, and wherein the patterned dry powder adheres to at least one of the one or more roughened surface regions.

5. The apparatus of claim 1, further comprising a cleaning device for cleaning the exterior surface of the intermediate substrate to remove residual powder after transferring the patterned dry powder to the upper surface of the target substrate.

6. The apparatus of claim 1, further comprising a conditioning unit for conditioning the exterior surface of the intermediate substrate, the conditioning unit comprising at least one of a film coating, spray coating, applying electric charge, or heating the exterior surface to improve at least one of a cohesiveness of the dry powder and an adhesion of the dry powder to the intermediate substrate.

7. The apparatus of claim 1, further comprising an energetic means of transferring energy to the powder to remove residual powder or disturb adhesion of the patterned dry powder from the exterior surface of the intermediate substrate, wherein the energetic means is selected from the group consisting of a vibration energy device, an acoustic energy device, and an ultrasonic energy device, and wherein the energetic means is communicably coupled to the exterior surface of the intermediate substrate.

8. The apparatus of claim 1, wherein the exterior surface of the intermediate substrate further comprises one or more surface features to facilitate powder adhesion, wherein the one or more surface features are incorporated into the pattern of the fused patterned layer during application of the pressing mechanism, and wherein the one or more surface features is selected from the group consisting of spikes, grooves, protrusions, pillars, guides, ridges, depressions, holes, channels, troughs, embossed patterns, engraved patterns, and stencils.

9. The apparatus of claim 1, further comprising a belt conveyor, the belt conveyor configured to move the target substrate in a longitudinal direction, horizontal to the volume enclosed, wherein at least one of the intermediate substrate and the belt conveyor is made of metal, stainless steel, metal alloy, polymers, or composites such as fiber composites.

10. The apparatus of claim 1, wherein the patterning device is a scanning laser which can selectively remove powder from the surface of the intermediate roller by laser powder removal.

11. The apparatus of claim 1, wherein the intermediate substrate is a roller made of metal, stainless steel, metal alloy, polymers, rubber coated metal, or composites such as fiber composites.

12. A method, comprising:
moving patterned dry powder on an exterior surface of an intermediate substrate towards a target substrate, the exterior surface further configured to move and enclose a volume;
forming patterned dry powder on the exterior surface of the intermediate substrate;
positioning the patterned dry powder vertically above an upper surface of the target substrate;
applying at least one of heat and pressure to the patterned dry powder positioned vertically above an upper surface of the target substrate to disrupt the adhesion of the patterned dry powder; and
transferring and adhering the patterned dry powder to the upper surface of the target substrate as a fused patterned layer.

13. The method of claim 12, further comprising moving the target substrate in a longitudinal direction, horizontal to the volume enclosed, and wherein the length of the fused patterned layer on the target substrate is equal to the length of the pressed and heated patterned dry powder.

14. The method of claim 12, wherein the exterior surface of the intermediate substrate comprises one or more roughened surface regions, and wherein forming patterned dry powder on the exterior surface of the intermediate substrate further comprises forming patterned dry powder on the one or more roughened surface regions.

15. The method of claim 12, further comprising cleaning the exterior surface of the intermediate substrate to remove residual powder after transferring the patterned dry powder to the upper surface of the target substrate.

16. The method of claim 12, further comprising conditioning the exterior surface of the intermediate substrate using at least one of a film coating, spray coating, applying electric charge, or heating the exterior surface to improve at least one of a cohesiveness of the dry powder and an adhesion of the dry powder to the intermediate substrate.

17. The method of claim 12, further comprising transferring energy to the powder using an energetic means to remove residual powder or disturb adhesion of the patterned dry powder from the exterior surface of the intermediate substrate, the energetic means is selected from the group consisting of vibration energy, acoustic energy, and ultrasonic energy, and wherein the energetic means is communicably coupled to the exterior surface of the intermediate substrate.

18. The method of claim 12, wherein the exterior surface of the intermediate substrate further comprises one or more surface features to facilitate powder adhesion, wherein applying heat and pressure to the patterned dry powder further comprises incorporating the one or more surface features into the pattern of the fused patterned layer, and wherein the one or more surface features is selected from the group consisting of spikes, grooves, protrusions, pillars, guides, ridges, depressions, holes, channels, troughs, embossed patterns, engraved patterns, and stencils.

19. The method of claim 12, wherein the intermediate substrate is a roller made of metal, stainless steel, metal alloy, polymers, rubber coated metal, or composites such as fiber composites.
